(19) United States
(12) Patent Application Publication
(10) Pub. No.: US 2015/0298354 A1
(43) Pub. Date: Oct. 22, 2015

(54) POWER TOOL WITH A SPRAYING DEVICE FOR BINDING DUST

(71) Applicant: Hilti Aktiengesellschaft, Schaan (LI)

(72) Inventors: Ralf Greitmann, Kaufering (DE); Oliver Ohlendorf, Landsberg (DE); Ralf Meixner, Germaringen (DE); Helmut Specht, Bad Woerishofen (DE)

(21) Appl. No.: 14/443,917

(22) PCT Filed: Nov. 19, 2013
(86) PCT No.: PCT/EP2013/074148

§ 371 Date: May 19, 2015

(30) Foreign Application Priority Data
Nov. 21, 2012 (DE) 10 2012 221 273.6

(51) Int. Cl. B28D 7/02; B28D 1/04

(52) U.S. Cl. CPC B28D 7/02; B28D 1/04

(57) ABSTRACT

A power tool (10) for processing a workpiece (23), including a processing tool (12) that can be rotated in a rotational direction (14) around an axis of rotation (15) by a drive (13), a protective hood (25) that surrounds the processing tool (12), at least partially, and a spraying device (11) with a first spray nozzle (37) and a pump (36) that is connected to the first spray nozzle (37) via a first connection line (38), whereby the pump (36) generates a minimum pressure of 5 bar in the first connection line (38).

The present invention relates to a power tool with a spraying device for binding dust, according to the generic part of claim 1.

The term “power tool” as set forth within the scope of the present invention encompasses all power tools that drive a processing tool in a rotating direction around an axis of rotation during the processing of a workpiece, whereby the axis of rotation is arranged relative to the workpiece surface at an angle that differs from 90°. Typical examples of such power tools are a wall saw, a disc grinder, an angle grinder and a circular saw.

### BACKGROUND

Processing concrete workpieces, ceramic construction workpieces (roof tiles, bricks, floor tiles, wall tiles), mineral workpieces (sandstone, porous concrete stones), etc. with power tools gives rise to dust that contains not only larger dust particles but also fine dust particles. The term “fine dust” refers to particles in the air that do not sink to the ground immediately but rather, remain in the atmosphere for a certain period of time. Fine dust is divided into fractions, depending on the particle size. The most important fractions are the fraction that can be inhaled (I-fraction) and the fraction that can enter the alveoli (A-fraction). An inhalable fraction refers to fine dust particles that are deposited and settle primarily in the nasal and pharyngeal passages, whereas the expression “fraction that can enter the alveoli” refers to fine dust particles that get all the way into the pulmonary vesicles, the so-called alveoli.

The inhalation of fine dust particles has a detrimental effect on the health of humans. In this context, it holds true that the smaller the fine dust particles are, the greater the risk of harm to health. Smaller fine dust particles penetrate further into the respiratory tract than larger fine dust particles and they get into areas from which they are not expelled during exhalation, as a result of which they are particularly harmful to health. Studies have shown that there is no fine dust particle concentration below which no health-hazardous consequences can be expected.

For this reason, it is not only elevated concentrations of fine dust particles that have a negative effect on health, but rather, even low concentrations of fine dust particles are already detrimental to health, especially when they are present over a prolonged period of time. Therefore, the fine dust burden should be as low as possible in order to minimize the risk of damage to the health of humans.

Familiar power tools with a spraying device for binding dust comprise a processing tool that is driven around an axis of rotation by a drive means and that covers a processing plane perpendicular to the axis of rotation, a protective hood that partially surrounds the processing tool, and the spraying device with at least one spray nozzle which produces a jet along a spraying direction.

European patent specification EP 1 349 714 B1 discloses a power tool configured as a handheld disc grinder with a spraying device for binding dust and for cooling the grinding disc. The spraying device comprises a pump that operates within the pressure range of 2 bar to 4 bar, and one or more spray nozzles arranged on the side of the grinding disc that enters the workpiece (entry side). The pump is driven by means of at least one drive component of the drive means. The pump of the spraying device, which operates within the pressure range of 2 bar to 4 bar, and the arrangement of the spray nozzles on the entry side of the grinding disc have proven to be unsuitable for binding fine dust particles, especially the fraction of the fine dust that can enter the alveoli.

International patent application WO 2004/0000501 A1 discloses another power tool configured as an angle grinder with a spraying device. The spraying device comprises a first spray nozzle for binding dust and a second spray nozzle for moistening the workpiece that is to be processed. The first spray nozzle produces a first jet along a first spraying direction and is arranged in the protective hood on the side of the grinding disc that exits the workpiece (exit side). The second spray nozzle produces a second jet along a second spraying direction and is arranged in the protective hood on the entry side of the grinding disc. The spraying device is implemented in two configurations that differ from each other in terms of the arrangement of the first and second spray nozzles and their spraying directions. In the first configuration, the first and second spray nozzles are located outside of the diameter of the processing tool configured as a grinding disc. The spraying directions run perpendicular, that is to say, at an angle of approximately 90°, relative to the axis of rotation, and the first and second jets strike perpendicularly onto the workpiece that is to be processed. In the second configuration, the first and second spray nozzles are located inside of the diameter of the grinding disc. The spraying directions of the first and second spray nozzles are each oriented at an angle of approximately 66° relative to a plane that is perpendicular to the processing plane and parallel to the axis of rotation of the workpiece that is to be processed, and slanted in the processing plane in the direction of the axis of rotation. The angle grinder does not have a pump to convey the liquid. A non-return valve to which a water line is connected is screwed into the protective hood of the angle grinder. The amount of liquid is likewise regulated by the non-return valve. The pressure of the liquid as it enters the spraying device is at least 3 bar so that the spray nozzles can generate a functional first and second jet.

The orientation of the jets relative to the processing tool as well as the pressure build-up in the spraying device described in international patent application WO 2004/0000501 A1 are disadvantageous for binding fine dust particles, especially the fraction of the fine dust that can enter the alveoli. The spraying device also has the drawback that the liquid is supplied via a water line of an external pipe system, so that the spraying device of the power tool can only be employed if a functioning pipe system is available.

### SUMMARY OF THE INVENTION

It is an object of the present invention to provide a spraying device for a power tool by means of which the fine dust burden is reduced for the operator during the processing of a workpiece using the power tool. In this context, particularly the fraction of the fine dust that can enter the alveoli and that is hazardous to health is to be reduced. Moreover, the amount of liquid needed for binding the dust should be as small as possible.

The present invention provides that the pump generates a minimum pressure of 5 bar in the first connection line. Especially preferably, the pump generates a pressure between 5 bar and 8 bar in the first connection line. A minimum pressure of 5 bar is necessary to create liquid drops. The high pressure and a corresponding first spray nozzle generate a first jet that can bind the fraction of the fine dust that can enter the alveoli.

Preferably, the throughput rate of the first spray nozzle is between 8 and 12 liters per hour. A suitable arrangement and orientation of the first spray nozzle and a minimum pressure of 5 bar in the first connection line to the first spray nozzle markedly reduce the amount of liquid needed for binding the dust. Instead of the usual throughput rates of several liters per minute, the throughput rate for the first spray nozzle in the spraying device according to the invention is merely a few liters per hour. This low throughput rate means that the contents of the reservoir last longer before it needs to be refilled, which is advantageous especially at construction sites without external supply lines. Moreover, the workpiece that is to be processed is not exposed to water unnecessarily.

Especially preferably, the first spray nozzle produces the first jet with liquid drops measuring between 40 μm and 150 μm. The fraction of the fine dust that can enter the alveoli can be bound by means of liquid drops measuring between 40 μm and 150 μm, in addition to which the demand for liquid is reduced in comparison to jets having larger liquid drops. Since the binding of the fraction that can enter the alveoli is bound by the first jet, the fine dust burden for the operator is reduced during the processing of the workpiece. Bound fine dust particles are not inhaled by the operator and are not deposited in the alveoli.

In a preferred embodiment, the first spraying direction is arranged at an angle of up to ±10° relative to a plane perpendicular to the processing plane and parallel to the axis of rotation. In this context, the first spraying direction is especially preferably arranged essentially parallel to the axis of rotation and thus perpendicular to the processing tool. Thanks to the virtually perpendicular arrangement of the first jet relative to the processing tool, the fraction of bound fine dust particles, particularly the fraction that can enter the alveoli, is higher than with jets that are oriented, for instance, perpendicular to the workpiece that is to be processed.

In a preferred embodiment, the spraying device has at least a second spray nozzle that produces a second jet along a second spraying direction, whereby the second spray nozzle is arranged on the side of the processing tool that enters the workpiece (entry side). The second spray nozzle can be advantageously used for diamond-tipped processing tools, for example, diamond saw blades or diamond grinding discs. The processing speed as well as the service life of diamond-tipped processing tools are increased by cooling the processing tool. Since the second spray nozzle is arranged on the entry side, the processing tool is cooled and lubricated before the processing tool enters the workpiece. Part of the liquid is drawn into the slit together with the processing tool and transported to the processing site of the processing tool. Cooling and lubricating the processing tool in the vicinity of the processing site serve to enhance the processing and the processing speed.

In addition to cooling and lubricating the processing tool, the second spray nozzle can promote the binding of the dust. If the liquid drops in the second jet are of an appropriate size, then fine dust particles that were not bound by the first jet can be bound by the second jet at the entry side. Since the processing tool is rotated around the axis of rotation, at least some of the fine dust particles that were not bound by the first jet are conveyed via the protective hood to the entry side. The second jet binds additional fine dust particles and reduces the burden caused to the operator by fine dust particles.

Preferably, the pump is connected to the second spray nozzle via the second connection line and it generates a minimum pressure of 5 bar in the second connection line. Especially preferably, the pump generates a pressure between 5 bar and 8 bar in the second connection line.

Particularly preferably, the throughput rate of the second spray nozzle is between 13 and 17 liters per hour. The arrangement and the orientation of the second spray nozzle and a minimum pressure of 5 bar in the second connection line leading to the second spray nozzle markedly reduce the amount of liquid needed for cooling and lubricating the processing tool.

Especially preferably, the second spray nozzle produces the second jet with liquid drops measuring between 40 μm and 150 μm. Small liquid drops measuring between 40 μm and 150 μm have the advantage that, when the cold liquid drops strike the heated processing tool, they evaporate and the resulting evaporation cold intensifies the cooling of the processing tool. Owing to the evaporation cold, along with the increased cooling effect, the amount of liquid needed is reduced in comparison to spray nozzles that generate larger liquid drops. Liquid drops measuring between 40 μm and 150 μm in the second jet are suitable not only to cool and lubricate the processing tool but also to bind fine dust particles that were not bound by the first jet. Some of the fine dust particles that were not bound by the first jet are conveyed to the entry side by the rotation of the processing tool around the axis of rotation, and are then bound by the second jet. The second jet captures additional fine dust particles, thus further reducing the fine dust burden for the operator.

Preferably, the second spraying direction is arranged at an angle of up to ±10° relative to a plane perpendicular to the processing plane and parallel to the axis of rotation. In this context, the second spraying direction is especially preferably arranged essentially parallel to the axis of rotation and thus perpendicular to the processing tool. The virtually perpendicular orientation of the second jet relative to the processing tool ensures that the liquid drops strike the processing tool and that the processing tool is thoroughly cooled.

In a preferred embodiment, the pump is driven by at least one drive component of the drive means. Driving the pump via the drive means has the advantage that there is no need for separate drive components for the pump. Dispensing with an electric drive component—whose installation would require an electrician—simplifies the retooling of the spray device in a power tool. The spraying device can be installed or replaced by an operator without any special skills

Especially preferably, the pump is driven by means of a crankshaft that is non-rotatably joined to a drive motor. Implementing the drive via the crankshaft has the advantage that driving the pump and thus feeding the liquid to the spray nozzles are coupled to the drive of the processing tool. Between the drive motor and the crankshaft, there is a centrifugal clutch that only transmits the driving motion of the drive motor to the crankshaft once a limit rotational speed has been exceeded. Liquid is fed to the spray nozzles whenever the processing tool is rotating, and this is interrupted when the processing tool is not being driven. Coupling the liquid feed to the drive of the processing tool reduces the amount of liquid needed since no unnecessary liquid is sprayed. On the other hand, it is ensured that liquid is sprayed during processing in order to bind dust and/or to cool and lubricate the processing tool.

Especially preferably, a transmission unit is arranged between the pump and the crankshaft. In this context, the transmission unit is especially preferably configured as a planetary gear train with a transmission ratio between 2 to 1 and 4 to 1. The transmission unit between the pump and the crankshaft reduces the high rotational speeds of the drive motor to a lower speed range that is permissible for the pump. The transmission unit is necessary in order to prevent damage to the pump due to the high rotational speeds of the drive motor. A planetary gear train is particularly well-suited to reduce the rotational speed as well as to adapt the transmission ratio of the planetary gear train to the rotational speeds of the drive means and to the maximum rotational speeds of the pump.

In a preferred embodiment, the pump and the transmission unit are fastened as a module to a mounting plate. Owing to this configuration as a module that can be fastened to a mounting plate that is provided, the pump and the transmission unit can be easily replaced. Moreover, a power tool can be retrofitted with the module as an accessory. The mounting plate is provided as a standard option with every power tool, so that each power tool lends itself to being retrofitted. Since the pump is driven via the drive means and since there is no need for an electrician to install the pump, the module with the pump and the transmission unit can be installed by the operator. The mounting plate simplifies the retrofitting for the operator.

Embodiments of the invention will be described below with reference to the drawing. The drawing does not necessarily depict the embodiments true-to-scale, but rather, the drawing—where necessary for the sake of elucidation—is shown in schematic and/or slightly distorted form. Regarding any additions to the teaching that can be gleaned directly from the drawing, reference is hereby made to the pertinent state of the art. Here, it should be kept in mind that many modifications and changes relating to the shape and to details of an embodiment can be made without departing from the general idea of the invention. The features of the invention disclosed in the description, in the drawing as well as in the claims can be essential for the refinement of the invention, either individually or in any desired combination. Moreover, all combinations of at least two of the features disclosed in the description, in the drawing and/or in the claims fall within the scope of the invention. The general idea of the invention is not limited to the exact form or detail of the preferred embodiment shown and described below nor is it limited to a subject matter that would be limited in comparison to the subject matter put forward in the claims. At given rated ranges, values that fall within the specified limits are also disclosed as limit values and can be used and claimed as desired. For the sake of clarity, identical or similar parts or else parts with an identical or similar function are designated by the same reference numerals below.

### BRIEF DESCRIPTION OF THE DRAWINGS

The following is shown:

FIG. 1: a power tool according to the invention, in the form of a handheld disc grinder with a spraying device having a first spray nozzle for binding dust and a second spray nozzle for cooling and lubricating the processing tool;

FIG. 2: a protective hood of the disc grinder shown in FIG. 1, in a schematic view with two first spray nozzles and two second spray nozzles;

FIG. 3: the drive components for a pump of the spraying device of the disc grinder in an exploded view; and

FIGS. 4A-D: four different spraying devices in a schematic view.

### DETAILED DESCRIPTION

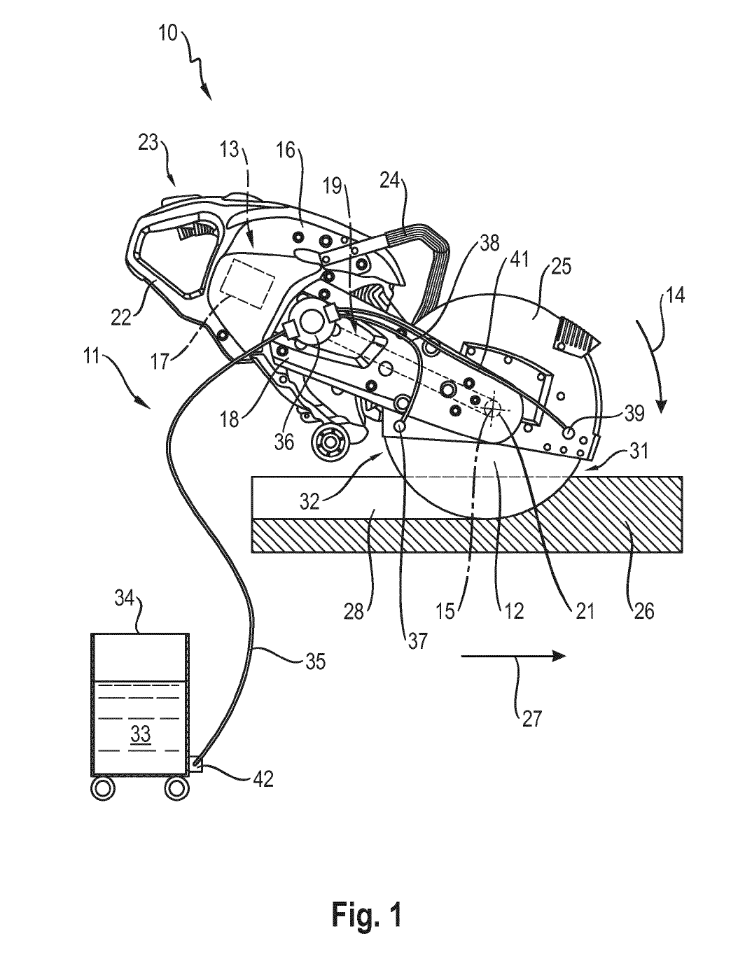

FIG. 1 shows a power tool 10 according to the invention, configured in the form of a handheld, gasoline-powered disc grinder with a spraying device 11 for binding dust that is generated during processing with the disc grinder 10. The disc grinder 10 comprises a processing tool in the form of a grinding disc 12 that is driven by a drive means 13 in a rotating direction 14 around an axis of rotation 15. In this context, the term “drive means” encompasses all drive components for the grinding disc 12. The drive means 13 of the disc grinder 10 shown in FIG. 1 comprises a drive motor 17 arranged in a motor housing 16, a belt drive 19 arranged in a support arm 18, and a driven shaft 21 on which the grinding disc 12 is mounted. If needed, additional drive components can be installed between the drive motor 17 and the belt drive 19.

For the operation of the disc grinder 10, a first handle 22 is provided which has an actuator 23 and which is configured as a rear handle in the embodiment shown in FIG. 1. The term “rear handle” refers to a handle that is situated on the side of the motor housing 16 facing away from the grinding disc 12. As an alternative, the first handle 22 can be configured as an upper handle that is arranged above the motor housing 16. In addition to the first handle 22, a second handle 24 is arranged between the grinding disc 12 and the first handle 22 in order to guide the disc grinder 10. In the embodiment shown in FIG. 1, the second handle 24 is configured as grip bar or, alternatively, it is configured in one piece with the motor housing 16. The grinding disc 12 is partially surrounded by a protective hood 25 that serves to protect the operator against swirling dust particles and also reduces the risk of injury that could occur if the operator were to reach into the rotating grinding disc 12 during the operation of the disc grinder 10. The protective hood 25 is fastened to the support arm 17 and is configured so that it can be adjusted around the driven shaft 21.

When a workpiece 26 is processed by means of the handheld disc grinder 10, the disc grinder 10 is moved by the operator along a feeding direction 27 over the workpiece 26 that is to be processed. Due to the rotation of the grinding disc 12 in the rotational direction 14 around the axis of rotation 15 and due to the movement of the disc grinder 10 along the feeding direction 27, a slit 28 is created in the workpiece 26. The grinding disc 12 digs into the workpiece 26 on an entry side 31 and exits the workpiece 26 on an exit side 32. In the case of the power tool 10 shown in FIG. 1, the rotational direction 14 of the processing tool 12 is oriented opposite from the feeding direction 27. This opposing arrangement of the rotational direction 14 and feeding direction 27 is referred to as climb-cut milling. In the case of gasoline-powered disc grinders, for safety reasons, it is common practice to orient the rotational direction 14 opposite to the feeding direction 27. With other power tools, such as, for instance, angle grinders, circular saws, the rotational direction of the processing tool generally has the same orientation as the feeding direction. This identical orientation of the rotational direction and the feeding direction is referred to as down-cut milling. There are power tools with which the user can choose between climb-cut milling and down-cut milling, depending on the processing task on hand.

The spraying device 11 serves, among other things, to bind dust that is generated during the processing of the workpiece 26 using the disc grinder 10. In this context, the spraying device 11 is configured in such a way that the fine dust concentration, especially the fraction that can enter the alveoli, is reduced. The fraction of the fine dust that can enter the alveoli is particularly harmful to health since the minute fine dust particles of the fraction that can enter the alveoli pass through the upper respiratory tract and reach the air vesicles in the lung (alveoli). The spraying device 11 comprises a reservoir 34 filled with a liquid 33, a supply line 35, a pump 36 and a first spray nozzle 37 that is connected to the pump 36 via a first connection line 38. The pump 36 is configured in the form of a diaphragm pump. A diaphragm pump is impervious to dirty water and is thus well-suited for use in gasoline-powered disc grinders that become very soiled during operation. Moreover, a diaphragm pump does not run dry and it is impervious to excess pressure from an external line system.

When it comes to diamond-tipped processing tools, for example, in the form of diamond saw blades or diamond grinding discs, it is advantageous to cool the processing tool 12, which is done by supplying a cooling liquid. Cooling improves the processing and prolongs the service life of the processing tool. When diamond-tipped processing tools are employed, the spraying device 11 has a second spray nozzle 39 to cool the processing tool 12. The second spray nozzle 39 is connected to the pump 36 via a second connection line 41. If necessary, the liquid 33 can be cleaned by means of one or more filter elements 42, whereby the filter elements 42 can be provided on the reservoir 34, in the supply line 35 and/or in the pump 36.

The requirements made of the first spray nozzle 37 differ from the requirements made of the second spray nozzle 39. The first spray nozzle 37 serves to bind the dust generated during grinding, while the second spray nozzle 39 serves to cool and lubricate the grinding disc 12 during grinding. Moreover, the first and second spray nozzles 37, 39 are installed on different sides of the grinding disc 12. The first spray nozzle 37 is arranged on the exit side 32 while the second spray nozzle 39 is arranged on the entry side 31 of the grinding disc 12. The arrangement of the first spray nozzle 37 on the exit side 32 has the advantage that the dust can be bound directly at the site where it is generated and the dust can be largely prevented from spreading. Owing to the arrangement of the second spray nozzle 39 on the entry side 31, the grinding disc 12 is cooled and lubricated before it enters the workpiece 26. Some of the liquid 33 is drawn into the slit 28 along with the grinding disc 12 and then transported to the processing site of the grinding disc 12. The cooling and lubrication of the grinding disc 12 in the area of the processing site improve the processing and increase the grinding speed.

The first and second spray nozzles 37, 39, as shown in FIG. 1, are supplied with liquid 33 from the external reservoir 34. The end of the supply line 35 facing away from the protective hood 25 has a connection element, for example, in the form of a Gardena hose connector that is connected to the external reservoir 34. As an alternative, the connection element can be connected to a line which, in turn, is connected to the reservoir 34. Instead of the external reservoir 34, the connection element can be connected to an external line system. In this context, the external reservoir 34 entails the advantage that processing with the disc grinder 10 can be carried out independently of a functional line system, in contrast to which an external line system is advantageous in the case of large amounts of liquid since there is no need to transport a full reservoir 34. In the case of processing tasks involving small amounts of liquid, the liquid 33 can be stored in an internal reservoir that is installed on the disc grinder 10. Since a full reservoir increases the total weight of the disc grinder 10, only small amounts of liquid can be stored without impairing the convenience for the operator.

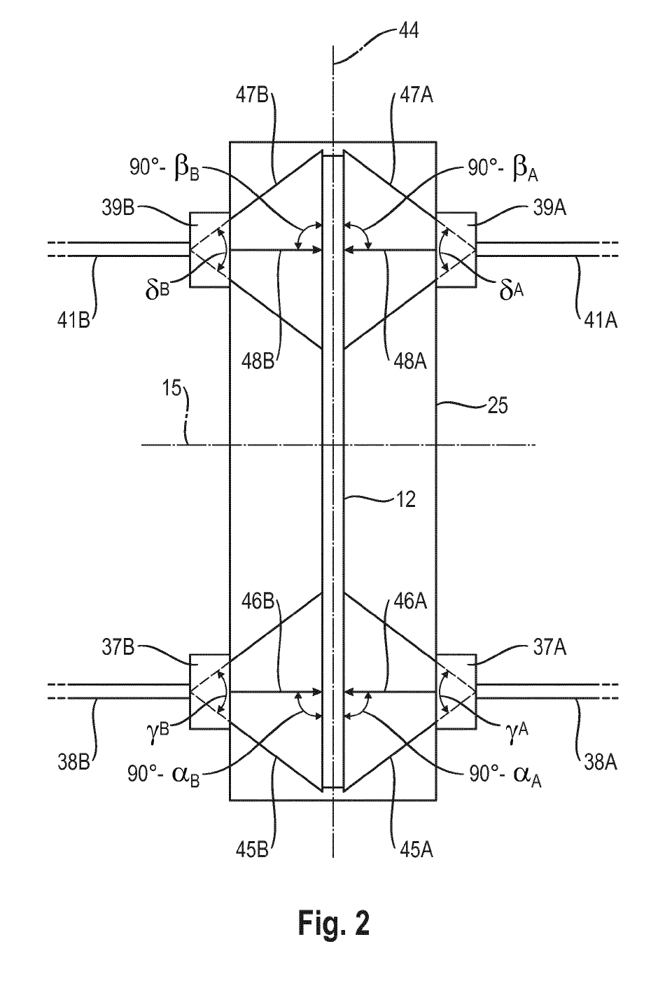

FIG. 2 shows the protective hood 25 of the disc grinder 10 in a schematic view. Two first spray nozzles 37A, 37B are arranged on the exit side 32 while two second spray nozzles 39A, 39B are arranged on the entry side 31 of the grinding disc 12. Perpendicular to the axis of rotation 15, the grinding disc 12 covers a grinding plane 44, whereby, in each case, a first spray nozzle 37A, 37B and a second spray nozzle 39A, 39B can be arranged to the right and left of the grinding plane 44. The letter “A” in the reference numeral denotes components on the right-hand side while the letter “B” denotes components on the left-hand side of the grinding plane 44. Starting from the pump 36, four parallel connection lines 38A, 38B, 41A, 41B open into the first and second spray nozzles 37A, 37B, 39A, 39B.

The liquid 33 is conveyed from the pump 36 via the connection lines 38A, 38B, 41A, 41B to the first and second spray nozzles 37A, 37B, 39A, 39B. The first spray nozzles 37A, 37B each generate a first jet 45A, 45B, which spreads out along a first spraying direction 46A, 46B, while the second spray nozzles 39A, 39B each generate a second jet 47A, 47B, which spreads out along a second spraying direction 48A, 48B. The first spraying directions 46A, 46B are arranged at angles α_{A}, α_{B} relative to the axis of rotation 15 or at an angle of 90°-α_{A}, 90°-α_{B} relative to the grinding plane 44 that runs perpendicular to the axis of rotation 15. The second spraying directions 48A, 48B are arranged at angles β_{A}, β_{B} relative to the axis of rotation 15 or at an angle of 90°-β_{A}, 90°-β_{B} relative to the grinding plane 44. In the embodiment shown in FIG. 2, the first spraying directions 46A, 46B of the first spray nozzles 37A, 37B and the second spraying directions 48A, 48B of the second spray nozzles 39A, 39A run virtually parallel to the axis of rotation 15. As an alternative to the parallel orientation, the first spraying directions 46A, 46B, 48A, 48B can be slanted by up to ±10° relative to a plane that runs perpendicular to the grinding plane 44 and parallel to the axis of rotation 15.

The first jets 45A, 45B bind the dust generated during the grinding. In order to bind the fine dust particles, especially the fraction of the fine dust that can enter the alveoli, by means of the first jets 45A, 45B, first spray nozzles 37A, 37B are used which create liquid drops measuring between 40 μm and 150 μm. In this process, the size of the liquid drops is set via the nozzle geometry of the first spray nozzles 37A, 37B, especially the diameter, and via the pressure in the first connection lines 38A, 38B. The pressure generated by the pump 36 is at least 5 bar. This minimum pressure is necessary in order to create liquid drops of the desired size. The first spray nozzles 37A, 37B are configured as full-cone nozzles which generate the first jets 45A, 45B at angles γ_{A}, γ_{B} approximately 75°. A large jet angle has the advantage that the first jets 45A, 45B strike a large volume area and can bind many dust particles.

The second jets 47A, 47B cool the grinding disc 12 during the grinding. In order to cool the grinding disc 12, the second spray nozzles 39A, 39B direct the second jets 47A, 47B along the second spraying direction 48A, 48B onto the grinding disc 12, whereby the second spraying direction 48A, 48B is directed at the grinding disc 12 essentially parallel to the grinding plane 44. In order to properly cool and lubricate the grinding disc 12, second spray nozzles 39A, 39B are employed which, like the first spray nozzles 37A, 37B, create liquid drops measuring between 40 μm and 150 μm. Small liquid drops ensure that, when the cold liquid drops strike the heated grinding disc 12, they evaporate and the resulting evaporation cold intensifies the cooling of the grinding disc 12. Owing to the evaporation cold, along with the increased cooling effect, the amount of liquid needed is reduced in comparison to spray nozzles that generate larger liquid drops. The second spray nozzles 39A, 39B are configured as full-cone nozzles which generate second jets 47A, 47B at angles δ_{A}, δ_{B} of approximately 75°. A large jet angle has the advantage that the second jets 47A, 47B, which are directed onto the grinding disc 12, strike and cool a surface area of the grinding disc 12. The more effectively the grinding disc 12 is cooled in the area of the processing site, the higher the grinding speed of the disc grinder 10.

For the second jets 47A, 47B, there is a need for a throughput rate that is higher than that of the first jets 45A, 45B. FIG. 2 shows an embodiment of a spraying device 11 with four parallel connection lines 38A, 38B, 41A, 41B that are connected to the pump 36 and that open into the spray nozzles 37A, 37B, 39A, 39B. Essentially the same pressure is present in all of the connection lines, so that different throughput rates can be set for the first and second spray nozzles 37A, 37B, 39A, 39B by means of the geometry of the spray nozzles 37A, 37B, 39A, 39B, without a need for additional flow regulators. The ratio of the throughput rate of the second spray nozzle 39A, 39B to that of the first spray nozzle 37A, 37B is between 1.2 and 1.5, that is to say, the throughput rate of the second spray nozzle 39A, 39B is between 20% and 50% greater than the throughput rate of the first spray nozzle 37A, 37B. As an alternative, different throughput rates can be set for the first and second jets 45A, 45B, 47A, 47B by means of one or more flow regulators. The throughput rate of the first and second spray nozzles 37A, 37B, 39A, 39B is between 8 and 17 liters per hour, for the first spray nozzles 37A, 37B, it is between 8 and 12 liters per hour, and for the second spray nozzles 39A, 39B, it is between 13 and 17 liters per hour. The high pressure of 5 bar to 8 bar and the small liquid drops drastically reduce the amount of liquid needed.

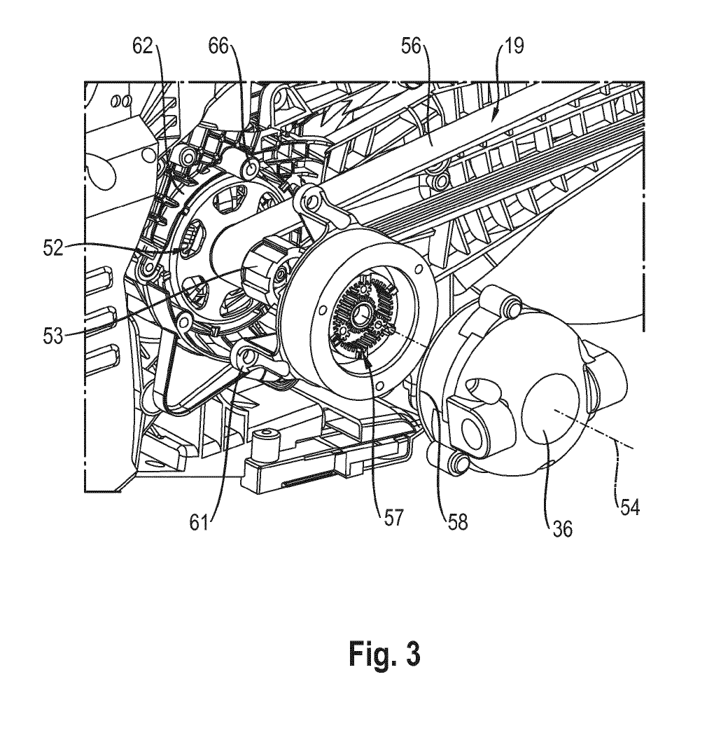

FIG. 3 shows the pump 36 of the spraying device 11 that is driven by the drive means 13 of the disc grinder 10. Here, the drive components of the drive means 13 and the pump 36 are shown in an exploded view. The drive means 13 comprises the drive motor 17, the belt drive 19 and the driven shaft 21 on which the grinding disc 12 is mounted. Between the drive motor 17 and the belt drive 19, there is a centrifugal clutch 52 that ensures that the grinding disc 12 does not rotate when the drive motor 17 is at low rotational speeds such as during idling or when the disc grinder 10 is started. The centrifugal clutch 52 has a bell housing against which the centrifugal weights are pressed outwards as a result of the centrifugal force. The drive motor 17 drives a crankshaft 53 around an axis of rotation 54. The bell housing of the centrifugal clutch 52 is non-rotatably joined to a drive disk that is rotatably mounted on the crankshaft 53. A drive belt 56 runs over the drive disk and a driven disk that is mounted on the driven shaft 21 (see FIG. 1). The drive disk, the drive belt 56 and the driven disk together form the belt drive 19.

The pump 36 is driven by the crankshaft 53. Due to the high rotational speeds of the drive motor 17, the pump 36 is not arranged directly on the crankshaft 53, but rather, a transmission unit 57 is installed between the crankshaft 53 and the pump 36. In the embodiment shown in FIG. 3, the transmission unit 57 is configured as a single-stage planetary gear train 57 with a transmission ratio of 3 to 1. The maximum speed of the drive motor 17 is, for instance, in the order of magnitude of 10,000 rpm and the permissible speed for the pump 36 is approximately 4,000 rpm. The planetary gear train 57 reduces the speed of the drive motor 17 from 10,000 rpm to approximately 3,340 rpm and thus to within the permissible rotational speed range. A gasket 58 is installed between the pump 36 and the planetary gear train 57. The pump 36, the planetary gear train 57 and the gasket 58 are fastened as a module 59 onto a mounting plate 61. Holes 66 having an internal thread for fastening the mounting plate 61 are provided on a housing part 62 of the disc grinder 10.

The pump 36 is switched on and off by means of the centrifugal clutch 52 that actuates the drive of the grinding disc 12. The driving movement of the drive motor 17 is only transmitted via the centrifugal clutch 52 to the grinding disc 12 once a limit rotational speed has been exceeded. The drive of the pump 36 feeds liquid to the spray nozzles 37A, 37B, 39A, 39B only when the grinding disc 12 is being driven around its axis of rotation 15. As soon as the limit rotational speed of the centrifugal clutch 52 has been exceeded, the centrifugal clutch 52 transmits the drive force of the drive motor 17 via the belt drive 19 to the grinding disc 12 and via the planetary gear train 57 to the pump 36. Consequently, the drive of the pump 36 and thus the liquid feed to the spray nozzles 37A, 37B, 39A, 39B are coupled to the drive of the grinding disc 12.

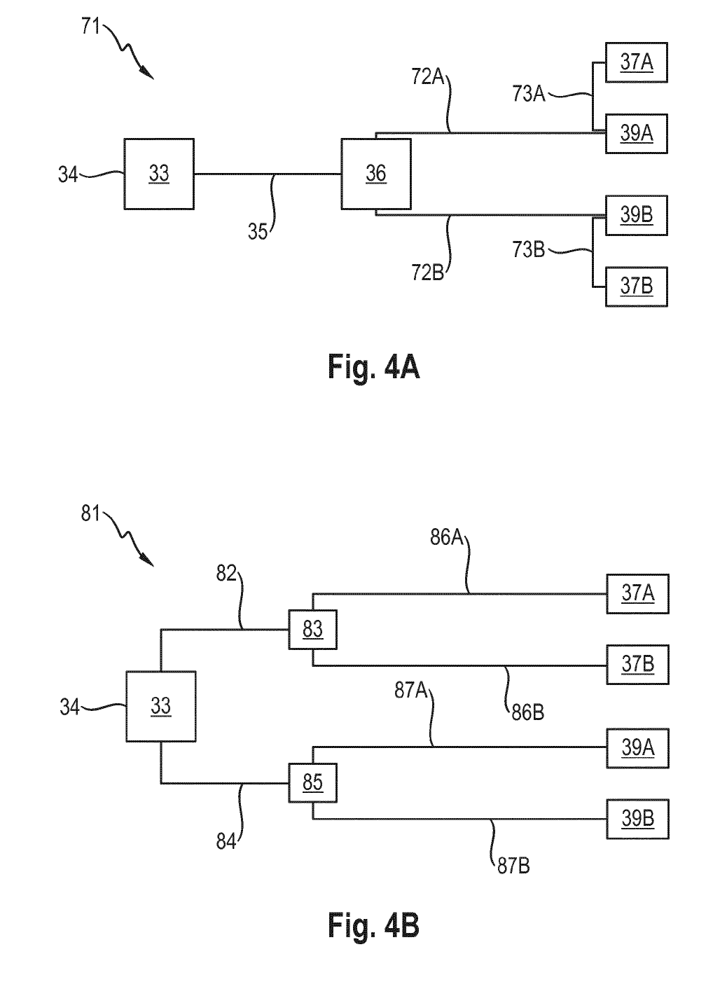

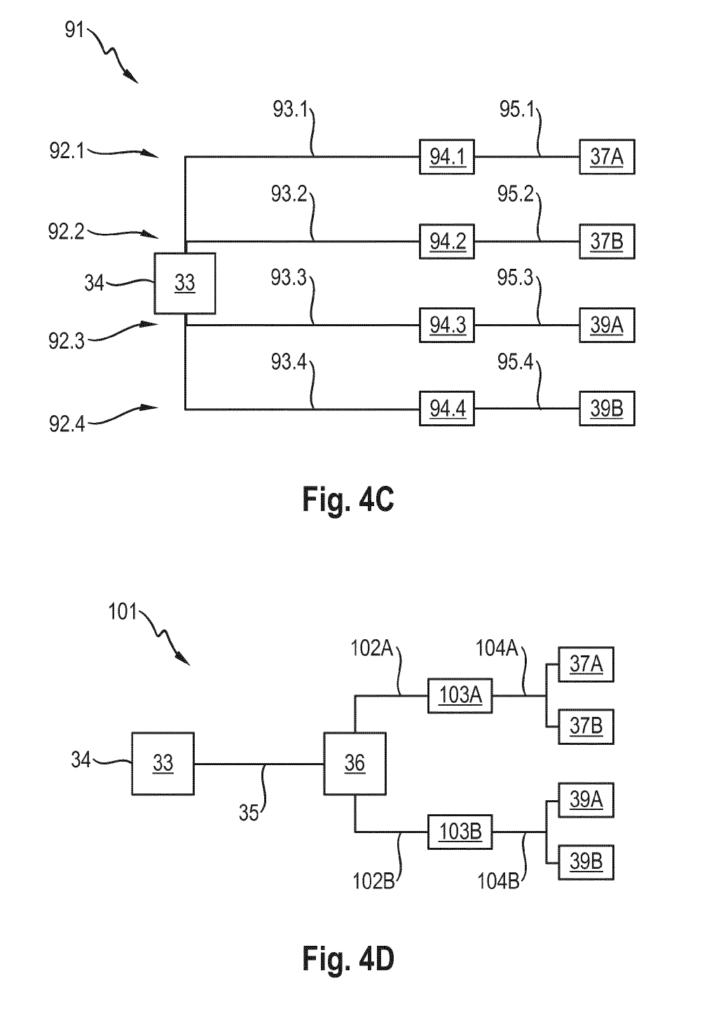

FIGS. 4A to 4D show a schematic view of four spraying devices that transport the liquid 33 to the first and second spray nozzles 37A, 37B, 39A, 39B. The spraying devices are suitable for power tools having a diamond-tipped processing tool that is supposed to be cooled during the processing. The first and second spray nozzles 37A, 37B, 39A, 39B correspond to the spray nozzles of the disc grinder 10 shown in FIG. 2, whereby the letter “A” in the reference numeral denotes components on the right-hand side while the letter “B” denotes components on the left-hand side of the grinding plane 44.

FIG. 4A shows a spraying device 71 that differs from the spraying device 11 of FIG. 2 in terms of the set-up of the connection lines from the pump 36 to the spray nozzles 37A, 37B, 39A, 39B. The liquid 33 is conveyed via the supply line 35 out of the reservoir 34 to the pump 36. The pump 36 consists of a single individual pump that generates a minimum pressure of 5 bar, or else of several pumps connected in series which together generate a minimum pressure of 5 bar.

The pump 36 is connected via a connection line 72A, 72B to the second spray nozzle 39A, 39B that is connected via an extension line 73A, 73B to the first spray nozzle 37A, 37B. The liquid 33 is transported via the connection line 72A, 72B to the second spray nozzle 39A, 39B and some of the transported liquid 33 is transported from the second spray nozzle 39A, 39B via the extension line 73A, 73B to the spray nozzle 37A, 37B.

If long lines are being used, a pressure drop that increases with the length of the line can occur. For this reason, in the case of the spraying device 71, the liquid 33 is first conveyed via the connection lines 72A, 72B to the second spray nozzles 39A, 39B, which have a higher throughput rate than the first spray nozzles 37A, 37B. Subsequently, the liquid is conveyed via the extension lines 73A, 73B to the first spray nozzles 37A, 37B. If the pressure in the lines between the pump 36 and the spray nozzles 37A, 37B, 39A, 39B is virtually constant, then the sequence in which the liquid 33 is fed to the spray nozzles 37A, 37B, 39A, 39B is of secondary importance. In this case, the pump 36 can at first be connected via connection lines to the first spray nozzles 37A, 37B, and subsequently, extension lines can connect the first spray nozzles 37A, 37B to the second spray nozzles 39A, 39B.

FIG. 4B shows a spraying device 81 in which the first spray nozzles 37A, 37B are provided with liquid 33 via a first supply line 82 and a first pump 83, while the second spray nozzles 39A, 39B are supplied with liquid 33 separately via a second supply line 84 and a second pump 85. The liquid 33 is transported from the first pump 84 via two parallel connection lines 86A, 86B to the first spray nozzles 37A, 37B and from the second pump 85 via two parallel connection lines 87A, 87B to the second spray nozzles 39A, 39B. The first and second pumps 83, 85 each consist of a single pump that generates the minimum pressure of 5 bar, or else of several pumps connected in series which together generate the minimum pressure of 5 bar.

The separate supply of the first and second spray nozzles 37A, 37B, 39A, 39B is advantageous whenever different requirements are being made of the first and second spray nozzles 37A, 37B, 39A, 39B. Instead of two parallel connection lines 86A, 86B which connect the first pump 83 to the first spray nozzles 37A, 37B, a connection line and an extension line can be provided, whereby the connection line connects one of the first spray nozzles 37A, 37B to the first pump 83, and the extension line connects the first spray nozzles 37A, 37B to each other. Analogously, the second spray nozzles 39A, 39B can be connected via a connection line and via an extension line to the second pump 85. Another alternative consists of using Y-lines that connect the first pump 83 to the first spray nozzles 37A, 37B and the second pump 85 to the second spray nozzles 39A, 39B.

FIG. 4C shows a spraying device 91 in which each spray nozzle 37A, 37B, 39A, 39B is supplied with liquid 33 via a separate supply unit 92.1-92.4 consisting of a supply line 93.1-93.4, a pump 94.1-94.4 and a connection line 95.1-95.4. The liquid 33, which is stored in the reservoir 34, is drawn in by the associated pump 94.1-94.4 via the associated supply line 93-1-983.4 and conveyed to the spray nozzles 37A, 37B, 39A, 39B via the associated connection line 95.1-95.4. The separate supply units 92.1-92.4 for each spray nozzle 37A, 37B, 39A, 39B entail the advantage that the pressure of the pump 94.1-94.4 can be set for each spray nozzle 37A, 37B, 39A, 39B.

FIG. 4D shows a spraying device 101 in which the throughput rates for the first and second spray nozzles 37A, 37B, 39A, 39B are set by means of pressure regulators. The liquid 33 is conveyed from the reservoir 34 via the supply line 35 to the pump 36 which is connected to two parallel connection lines 102A, 102B. In the first connection line 102A, there is a first flow regulator 103A which sets the throughput rate in a downstream first extension line 104A configured as a Y-line. The liquid 33 is fed to the first spray nozzles 37A, 37B via the first extension line 104A. The liquid 33 is fed to the second spray nozzles 39A, 39B via the second connection line 102B and via a second extension line 104B configured as a Y-line, whereby the throughput rate in the second extension line 104B can be set by means of a second flow regulator 103B.

In an alternative embodiment to FIG. 4D, only one flow regulator—either the first flow regulator 103A for the first spray nozzles 37A, 37B or the second flow regulator 104A for the second spray nozzles 39A, 39B—is provided. The spray nozzles without a setting modality for the throughput rate are adapted to their requirements by means of the appropriate pressure and geometry, and they have a throughput rate that is appropriate for binding dust (first spray nozzle) or for cooling and lubricating the processing tool (second spray nozzle). The throughput rate of the spray nozzles with a setting modality for the throughput rate is set by means of the flow regulator.

1-15. (canceled)

16. A power tool for processing a workpiece, the power tool comprising
a processing tool rotatable in a rotational direction around an axis of rotation by a drive, and covering a processing plane perpendicular to the axis of rotation;
a protective hood surrounding the processing tool, at least partially;
a spraying device with a first spray nozzle producing a first jet along a first spraying direction; and
a pump connected to the first spray nozzle via a first connection line, the pump generating a minimum pressure of 5 bar in the first connection line.

17. The method as recited in claim 16 wherein the pump generates a pressure between 5 bar and 8 bar in the first connection line.

18. The power tool as recited in claim 16 wherein a throughput rate of the first spray nozzle is between 8 and 12 liters per hour.

19. The power tool as recited in claim 18 wherein the first spray nozzle produces liquid drops measuring between 40 μm and 150 μm as the first jet.

20. The power tool as recited in claim 16 wherein the first spraying direction is arranged at an angle of up to ±10° relative to a plane perpendicular to the processing plane and parallel to the axis of rotation.

21. The power tool as recited in claim 16 wherein the spraying device has a second spray nozzle producing a second jet along a second spraying direction, the second spray nozzle being arranged on a side of the processing tool entering the workpiece.

22. The power tool as recited in claim 21 wherein the pump is connected to the second spray nozzle via a second connection line and generates a minimum pressure of 5 bar in the second connection line.

23. The power tool as recited in claim 22 wherein the throughput rate of the second spray nozzle is between 13 and 17 liters per hour.

24. The power tool as recited in claim 23 wherein the second spray nozzle produces liquid drops measuring between 40 μm and 150 μm as the second jet.

25. The power tool as recited in claim 21 wherein the second spraying direction is arranged at an angle of up to ±10° relative to the plane perpendicular to the processing plane and parallel to the axis of rotation.

26. The power tool as recited in claim 16 wherein the pump is driven by at least one drive component of the drive.

27. The power tool as recited in claim 26 wherein the pump is driven by a crankshaft non-rotatably joined to a drive motor.

28. The power tool as recited in claim 27 further comprising a transmission unit arranged between the pump and the crankshaft.

29. The power tool as recited in claim 28 wherein the transmission unit is configured as a planetary gear train with a transmission ratio between 2 to 1 and 4 to 1.

30. The power tool as recited in claim 28 wherein the pump and the transmission unit are fastened as a module to a mounting plate.
